(19) United States
(12) Patent Application Publication
(10) Pub. No.: US 2026/0267727 A1
(43) Pub. Date: Sep. 10, 2026

(54) INFORMATION PROCESSING APPARATUS, INFORMATION PROCESSING METHOD, AND PROGRAM

(71) Applicants: SONY GROUP CORPORATION, Tokyo (JP); SONY INTERACTIVE ENTERTAINMENT INC., Tokyo (JP)

(72) Inventors: Chikako ASAI, Tokyo (JP); Kento NAKADA, Tokyo (JP); Kotaro IRYO, Tokyo (JP)

(73) Assignees: SONY GROUP CORPORATION, Tokyo (JP); SONY INTERACTIVE ENTERTAINMENT INC., Tokyo (JP)

(21) Appl. No.: 18/724,651

(22) PCT Filed: Dec. 28, 2022
(86) PCT No.: PCT/JP2022/048441

§ 371 Date: Jun. 27, 2024

(30) Foreign Application Priority Data
Jan. 20, 2022 (JP) 2022-006941

(51) Int. Cl. G06F 11/07; G06T 11/26

(52) U.S. Cl. CPC G06F 11/079; G06F 11/0721; G06T 11/26

(57) ABSTRACT

An information processing apparatus according to the present technology includes a presentation control unit that generates presentation information corresponding to a combination of a detection result obtained by a first detection model that detects an abnormality in time-series data by using auxiliary data related to variation in the time-series data and a detection result obtained by a second detection model that detects an abnormality in the time-series data without using the auxiliary data. The present technology can be applied to, for example, an information processing apparatus that monitors sales data.

### FIELD

The present technology relates to an information processing apparatus, an information processing method, and a program, and more particularly, to an information processing apparatus, an information processing method, and a program that can reduce detection failure of an abnormality while determining a cause of the abnormality in time-series data.

### BACKGROUND

Time-series prediction has been performed by using a prediction model acquired by learning using time-series data and auxiliary data related to variation in the time-series data. For example, Patent Literature 1 describes a technique for predicting people flow at an exhibition by using a prediction model acquired by learning using the number of visitors to the exhibition for each time zone and attribute data indicating content of the exhibition. In the technique described in Patent Literature 1, a prediction result to which a prediction reason is added is displayed.

### Citation List

### Patent Literature

Patent Literature 1: WO 2021/192190 A

### SUMMARY

### Technical Problem

In general, in the time-series prediction, the prediction accuracy of the prediction model is expected to be improved in a case where the auxiliary data is used for learning as compared with a case where learning is performed using only the time-series data. On the other hand, in a case where the abnormality in the time-series data is detected by using the prediction result of the prediction model, if the prediction model using the auxiliary data for learning is used, the variation in the time-series data caused by the information indicated by the auxiliary data cannot be detected as an abnormality.

Therefore, it is conceivable to perform the abnormality detection of the time-series data by using a prediction result of a prediction model acquired without using the auxiliary data. However, in this case, it is not possible to determine whether the cause of the variation in the time-series data detected as an abnormality is the information indicated by the auxiliary data.

The present technology has been made in view of such a situation, and an object thereof is to reduce detection failure of an abnormality while enabling a cause of the abnormality in the time-series data to be determined.

### Solution to Problem

An information processing apparatus in one aspect of the present disclosure includes a presentation control unit that generates presentation information corresponding to a combination of a detection result obtained by a first detection model that detects an abnormality in time-series data by using auxiliary data related to variation in the time-series data and a detection result obtained by a second detection model that detects an abnormality in the time-series data without using the auxiliary data.

An information processing method performed by the information processing apparatus in one aspect of the present disclosure, includes generating presentation information corresponding to a combination of a detection result obtained by a first detection model that detects an abnormality in time-series data by using auxiliary data related to variation in the time-series data and a detection result obtained by a second detection model that detects an abnormality in the time-series data without using the auxiliary data.

A program in one aspect of the present disclosure, causes a computer to execute processing of generating presentation information corresponding to a combination of a detection result obtained by a first detection model that detects an abnormality in time-series data by using auxiliary data related to variation in the time-series data and a detection result obtained by a second detection model that detects an abnormality in the time-series data without using the auxiliary data.

In one aspect of the present technology, presentation information corresponding to a combination of a detection result obtained by a first detection model that detects an abnormality in time-series data by using auxiliary data related to variation in the time-series data and a detection result obtained by a second detection model that detects an abnormality in the time-series data without using the auxiliary data is generated.

### BRIEF DESCRIPTION OF DRAWINGS

FIG. 1 is a block diagram illustrating a configuration example of an information processing apparatus according to an embodiment of the present technology.

FIG. 2 is a diagram illustrating an example of sales data.

FIG. 3 is a diagram illustrating an example of a degree of contribution of past sales data and a feature amount of auxiliary data to respective prediction values.

FIG. 4 is a diagram illustrating an example of a threshold for detecting an abnormality.

FIG. 5 is a diagram illustrating an example of an alert pattern.

FIG. 6 is a diagram illustrating another example of the alert pattern.

FIG. 7 is a diagram illustrating an example of information displayed on a user interface unit.

FIG. 8 is a diagram illustrating a flow in which a ser uses the information processing apparatus.

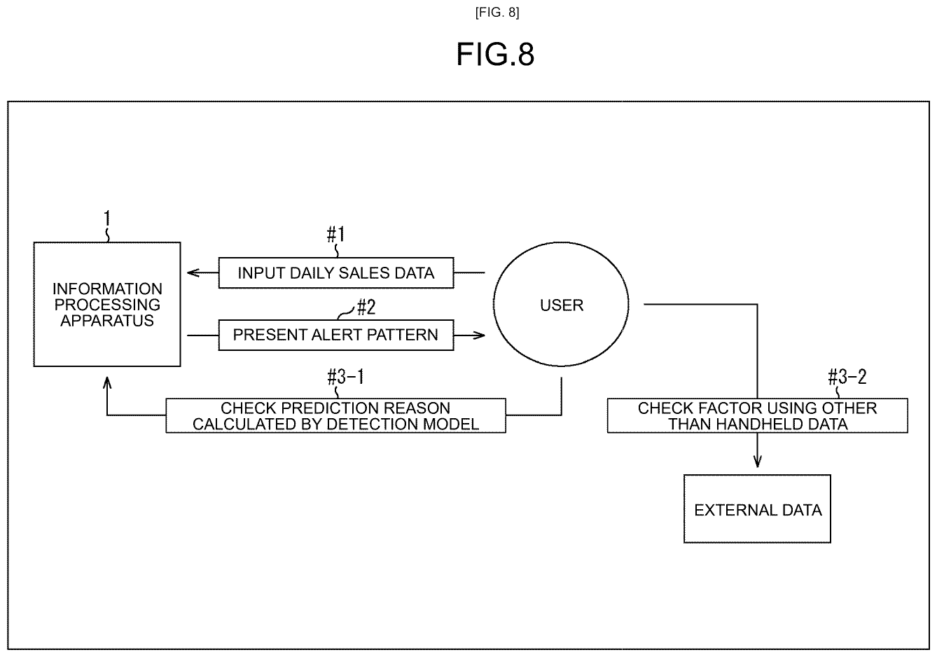

FIG. 9 is a flowchart for describing processing performed by the information processing apparatus.

FIG. 10 is a block diagram illustrating a configuration example of hardware of a computer.

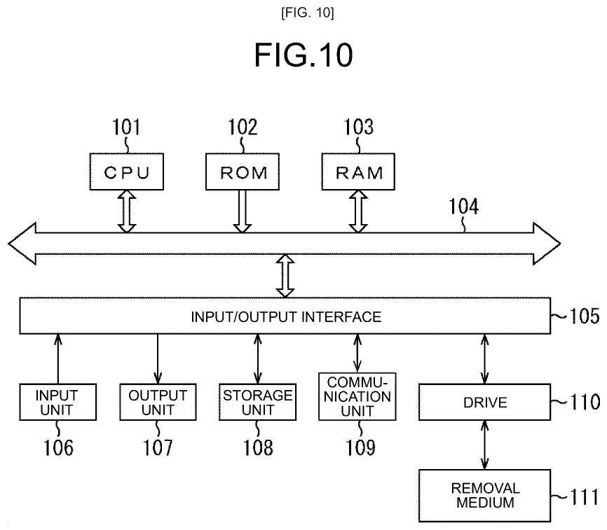

### DESCRIPTION OF EMBODIMENTS

Hereinafter, modes for carrying out the present technology will be described. The description will be given in the following order.
1. Configuration of information processing apparatus
2. Operation of information processing apparatus

### 1. Configuration of Information Processing Apparatus

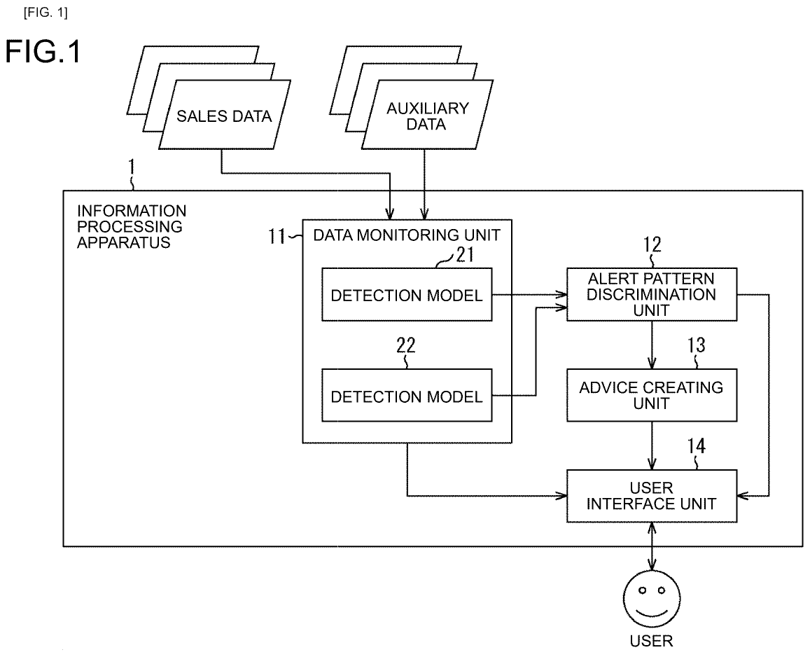

FIG. 1 is a block diagram illustrating a configuration example of an information processing apparatus 1 according to an embodiment of the present technology.

An information processing apparatus 1 in FIG. 1 is a system that monitors time-series data by using a first detection model that detects an abnormality in the time-series data by using auxiliary data related to variation in the time-series data, and a second detection model that detects an abnormality in the time-series data without using the auxiliary data.

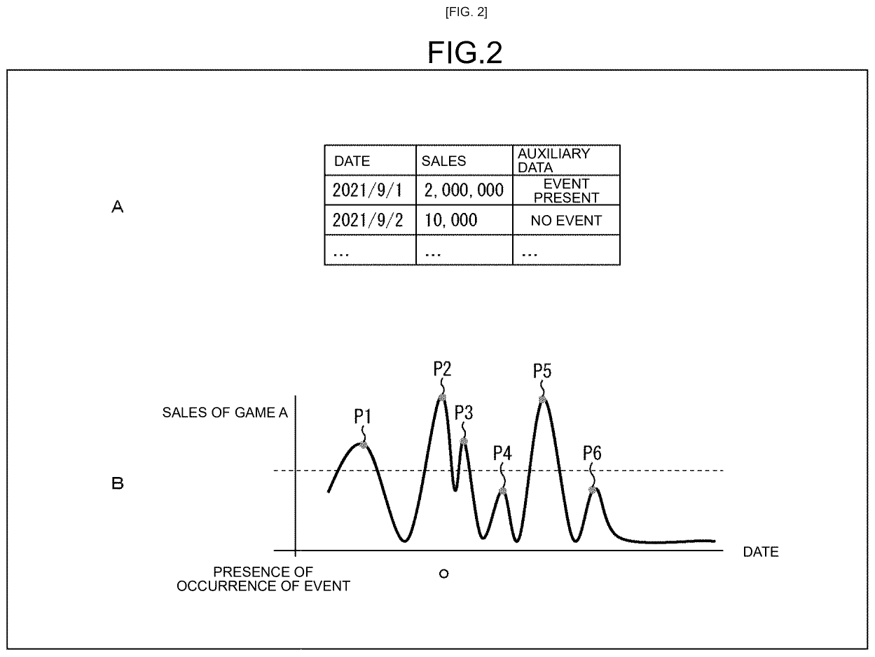

The information processing apparatus 1 is used, for example, for monitoring sales data in a predetermined game title. In this case, the auxiliary data indicates the presence of an event of the game related to variation in the sales, the release status of the new series, and the like. For example, as illustrated in A of FIG. 2, the sales data indicates a sales value of a game A for each date, and the auxiliary data indicates the presence of an event in the game A for each date.

In this case, the information processing apparatus 1 is configured to detect peaks P1 to P6 of the sales value of the game A illustrated in B of FIG. 2 as abnormalities. In B of FIG. 2, the horizontal axis represents the date, and the vertical axis represents the sales value of the game A. In addition, the lower side of the date indicates the presence of occurrence of an event. The user can monitor daily sales with the information processing apparatus 1, look at the information regarding the sales value in which the abnormality has been detected, the information being presented by the information processing apparatus 1, and investigate the reason for the sales being high.

As illustrated in FIG. 1, the information processing apparatus 1 includes a data monitoring unit 11, an alert pattern discrimination unit 12, an advice creating unit 13, and a user interface unit 14.

The data monitoring unit 11 includes a detection model 21 and a detection model 22. The data monitoring unit 11 receives inputs of the sales data and the auxiliary data, and detects an abnormality in the sales data by the detection model 21 and the detection model 22. Specifically, the data monitoring unit 11 inputs the input sales data and auxiliary data to the detection model 21.

In addition, the data monitoring unit 11 inputs only the input sales data to the detection model 22. Further, the data monitoring unit 11 supplies the sales data to the user interface unit 14.

The detection model 21 is an inference model acquired in advance by learning using the sales data and the auxiliary data. For example, it is conceivable that the detection model 21 learns that “the sales value is large on the day on which an event occurs”, on the basis of the sales data and a feature amount of the auxiliary data as the learning data.

At the time of monitoring the sales data, the detection model 21 detects an abnormality in the sales data by using the auxiliary data. Specifically, when the sales data and the auxiliary data are input from the data monitoring unit 11, the detection model 21 acquires a prediction value corresponding to the input sales data on the basis of the past sales data and the feature amount of the auxiliary data. The detection model 21 detects an abnormality in the time-series data by comparing the input sales data with the prediction value. For example, in a case where the difference between the sales data and the prediction value is larger than a predetermined threshold, the detection model 21 detects the sales value as an abnormality and outputs an alert. Because the detection model 21 is an inference model acquired by learning, even auxiliary data indicating discrete values can be utilized for prediction of sales.

In addition, the detection model 21 outputs information indicating a factor by which the prediction value has been acquired (reason for predicting the prediction value) and a degree of contribution of each factor to the prediction value. The prediction reason includes the past sales data and the feature amount of the auxiliary data which have a high degree of contribution to the prediction value.

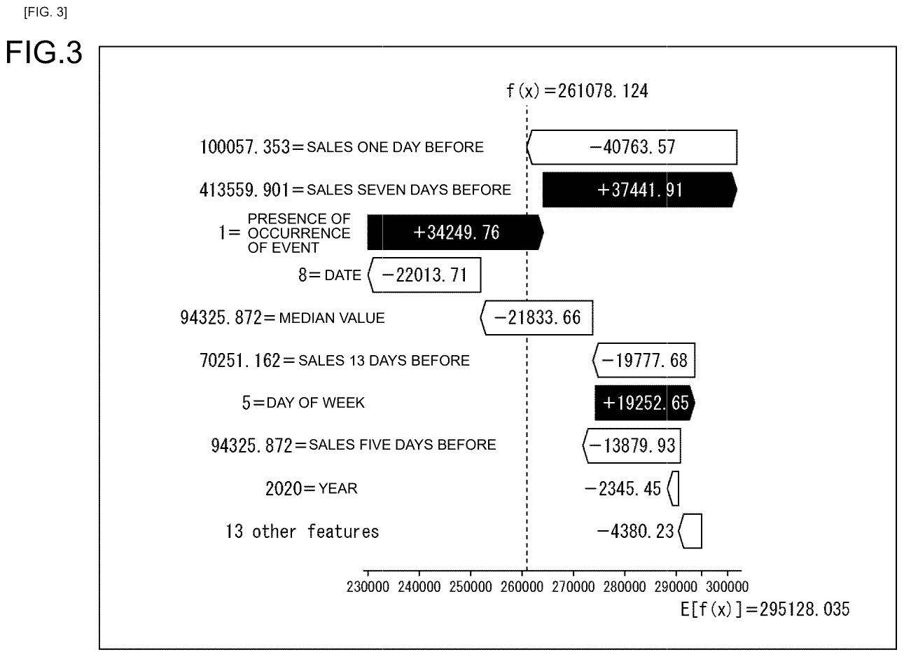

FIG. 3 is a diagram illustrating an example of the degree of contribution of the past sales data and the feature amount of the auxiliary data to the respective prediction values. In FIG. 3, the vertical axis represents the past sales data and the feature amount of the auxiliary data, and the horizontal axis represents the contribution to the prediction value.

In the example of FIG. 3, the past sales data mainly contributing to the prediction of the sales value of the date of the input sales data includes the sales value one day before the date of the input sales data, the sales value five days before, the sales value seven days before, the sales value thirteen days before, and the median value of the sales values. In addition, the presence of occurrence of an event, the date, the day of the week, and the year are the feature amounts of the auxiliary data mainly contributing to the prediction of the sales value of the date of the input sales data.

The fact that the presence of the occurrence of the event is 1 indicates that the event has occurred on the date of the input sales data. For example, the occurrence of the event is a factor of increasing the prediction value by 34249.76.

The degree of contribution to the prediction value is calculated, for example, by using SHapley Additive explanations (SHAP) of an open source library. In the SHAP, various types of data such as a table, a text, an image, time-series data, and music data can be used, and the degree of contribution of the feature amount to the prediction value in any model can be calculated. The reason for predicting the prediction value for each date and the entire detection model 21 can be described by the SHAP.

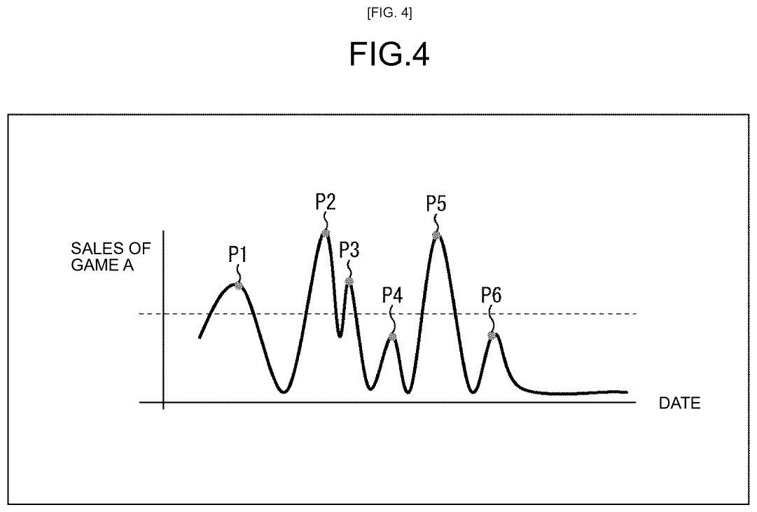

Returning to FIG. 1, the detection model 22 detects an abnormality in the sales data without using the auxiliary data. Specifically, the detection model 22 detects, as an abnormality, a sales value exceeding a threshold indicated by a broken line in FIG. 4 among the sales values of the sales data input from the data monitoring unit 11, and outputs an alert. In the example of FIG. 4, the peaks P1, P2, P3, and P5 are detected as abnormalities by the detection model 22.

Note that the detection model 22 can also detect an abnormality in the sales data on the basis of, for example, a moving average of sales values. In this case, for example, the detection model 22 detects, as an abnormality, a sales value that greatly deviates from the moving average and varies.

The alert pattern discrimination unit 12 discriminates an alert pattern indicating a combination of alerts output from the detection model 21 and the detection model 22, and supplies information indicating the alert pattern to the advice creating unit 13. In addition, the alert pattern discrimination unit 12 supplies information indicating the alert pattern and information indicating the prediction reason output from the detection model 21 to the user interface unit 14.

The advice creating unit 13 generates advice corresponding to the alert pattern discriminated by the alert pattern discrimination unit 12, as presentation information to be presented to the user.

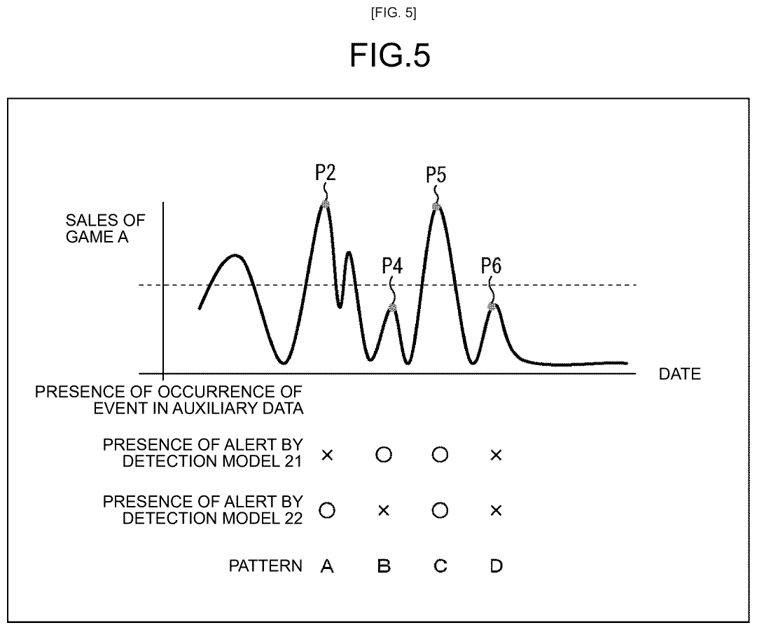

FIG. 5 is a diagram illustrating an example of the alert pattern. In the example of FIG. 5, the alert patterns for the peaks P2, P4, P5, and P6 are illustrated. Here, it is assumed that no event related to the variation of sales has occurred on the dates of the peaks P2, P4, P5, and P6.

In the alert pattern A, for the peak P2, an alert is not output by the detection model 21, and an alert is output by the detection model 22. The detection model 21 predicts the sales value to be large on the basis of the past sales data and the feature amount of the auxiliary data, and does not output the alert because the difference between the actual measurement value of the input sales and the prediction value is small. The detection model 22 outputs an alert because the actual measurement value of the sales exceeds the threshold.

In this case, because the prediction of the sales value by the detection model 21 has succeeded, the advice creating unit 13 creates, for example, advice of urging the user to investigate the cause of the rapid increase in sales by checking the prediction reason obtained by the detection model 21. The user who looks at the advice presented by the information processing apparatus 1 can check the prediction reason obtained by the detection model 21 and know that, for example, the day of the week or the like is a trigger for increasing the sales.

In the alert pattern B, for the peak P4, an alert is output by the detection model 21, and an alert is not output by the detection model 22. The detection model 21 outputs an alert because the difference between the actual measurement value of the input sales and the prediction value is large. The detection model 22 does not output an alert because the actual measurement value of the sales does not exceed the threshold.

In this case, because the prediction of the sales value by the detection model 21 has failed, the prediction reason obtained by the detection model 21 is possibly incorrect. Therefore, the advice creating unit 13 creates, for example, advice of urging the user to investigate the cause of the rapid increase in sales by checking data other than the prediction reason obtained by the detection model 21 and the presence of occurrence of an event.

The sales value at the date of the peak P4 is small as the sales value, but increases rapidly from the sales value at the most recent date. In this case, if only the detection model 22 is used to detect the abnormality in the sales data, detection failure of the peak P4 possibly occurs. The information processing apparatus 1 can prevent the detection failure of the abnormality in the sales data by using the detection model 21 and the detection model 22.

In the alert pattern C, for the peak P5, an alert is output by the detection model 21, and an alert is output by the detection model 22. The detection model 21 outputs an alert because the difference between the actual measurement value of the input sales and the prediction value is large. The detection model 22 outputs an alert because the actual measurement value of the sales exceeds the threshold.

In this case, because the sales has rapidly increased due to the reason other than the presence of occurrence of an event, the prediction of the sales value by the detection model 21 has failed, and thus, the prediction reason obtained by the detection model 21 is possibly incorrect. Therefore, the advice creating unit 13 creates, for example, advice of urging the user to investigate the cause of the rapid increase in sales by checking data other than the prediction reason obtained by the detection model 21 and the presence of occurrence of an event.

In the alert pattern D, for the peak P6, an alert is not output by the detection model 21, and an alert is not output by the detection model 22. The detection model 21 does not output an alert because the difference between the actual measurement value of the input sales and the prediction value is small. The detection model 22 does not output an alert because the actual measurement value of the sales does not exceed the threshold.

In this case, detection failure of the peak P6 occurs, but the user can check a rapid increase in sales by looking at the graph in which the sales data is visualized. Because the prediction of the sales value by the detection model 21 has succeeded, the user can check the prediction reason obtained by the detection model 21 and know the cause of the rapid increase in sales. Note that the advice creating unit 13 may create advice of urging the user to investigate the cause of the variation in sales by checking the prediction reason obtained by the detection model 21 and may present the advice to the user.

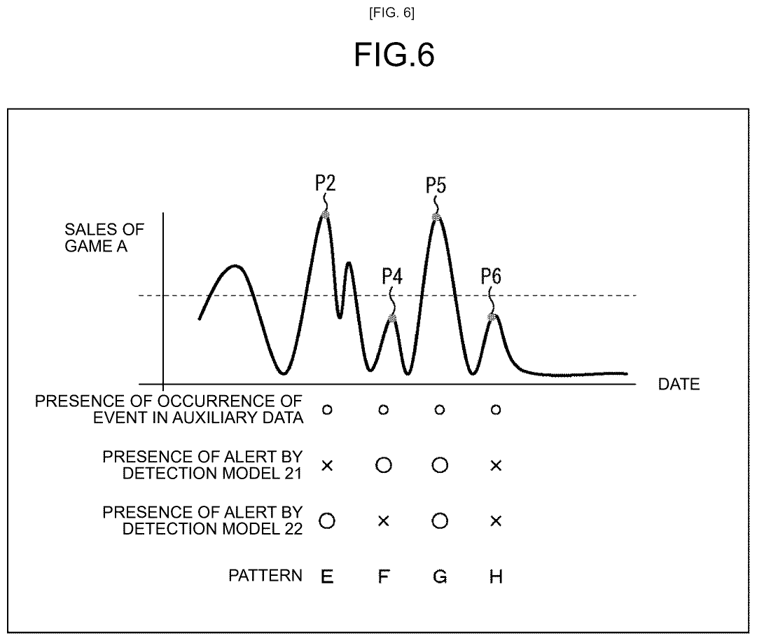

FIG. 6 is a diagram illustrating another example of the alert pattern. In the example of FIG. 6, the alert patterns for the peaks P2, P4, P5, and P6 are illustrated. Here, it is assumed that event related to the variation of sales has occurred on the dates of the peaks P2, P4, P5, and P6.

In the alert pattern E, for the peak P2, an alert is not output by the detection model 21, and an alert is output by the detection model 22. The detection model 21 predicts the sales value to be large on the basis of the past sales data and the feature amount of the auxiliary data, and does not output the alert because the difference between the actual measurement value of the input sales and the prediction value is small. The detection model 22 outputs an alert because the actual measurement value of the sales exceeds the threshold.

In this case, because the prediction of the sales value by the detection model 21 has succeeded, the advice creating unit 13 creates, for example, advice of urging the user to investigate the cause of the rapid increase in sales by checking the prediction reason obtained by the detection model 21. The user who looks at the advice presented by the information processing apparatus 1 can check the prediction reason obtained by the detection model 21 and know that, for example, the occurrence of an event is a trigger for increasing the sales.

In the alert pattern F, for the peak P4, an alert is output by the detection model 21, and an alert is not output by the detection model 22. For example, in a case where the detection model 21 has learned that “the sales value on Monday is small”, in a case where the date of the peak P4 is on Monday, in some cases, the detection model 21 predicts the sales value to be small on the basis of other feature amounts such as the day of the week even if the event has occurred. The detection model 21 outputs an alert because the difference between the actual measurement value of the input sales and the prediction value is large. The detection model 22 does not output an alert because the actual measurement value of the sales does not exceed the threshold.

In this case, because the prediction of the sales value by the detection model 21 has failed, the prediction reason obtained by the detection model 21 is possibly incorrect. Therefore, the advice creating unit 13 creates, for example, advice of urging the user to investigate the cause of the rapid increase in sales by checking data other than the prediction reason obtained by the detection model 21 and the presence of occurrence of an event.

In the alert pattern G, for the peak P5, an alert is output by the detection model 21, and an alert is output by the detection model 22. For example, the detection model 21 has predicted the sales value to be large on the basis of occurrence of an event, but because the occurred event is an event larger than a normal event, in some cases, the actual measurement value of the sales becomes a value larger than the prediction value. The detection model 21 outputs an alert because the difference between the actual measurement value of the input sales and the prediction value is large. The detection model 22 outputs an alert because the actual measurement value of the sales exceeds the threshold.

In this case, because the prediction of the sales value by the detection model 21 has failed, the prediction reason obtained by the detection model 21 is possibly incorrect. Therefore, the advice creating unit 13 creates, for example, advice of urging the user to investigate the cause of the rapid increase in sales by checking data other than the prediction reason obtained by the detection model 21. The user who looks at the advice presented by the information processing apparatus 1 can investigate the cause of the rapid increase in sales by checking the content of the event or the like. Note that the content of the event may be presented together with the advice by the information processing apparatus 1.

In the alert pattern H, for the peak P6, an alert is not output by the detection model 21, and an alert is not output by the detection model 22. The detection model 21 does not output an alert because the difference between the actual measurement value of the input sales and the prediction value is small. The detection model 22 does not output an alert because the actual measurement value of the sales does not exceed the threshold.

In this case, detection failure of the peak P6 occurs, but the user can check a rapid increase in sales by looking at the graph in which the sales data is visualized. Because the prediction of the sales value by the detection model 21 has succeeded, the user can check the prediction reason obtained by the detection model 21 and know the cause of the rapid increase in sales.

The advice creating unit 13 supplies the user interface unit 14 in FIG. 1 with information indicating the advice on the cause of the abnormality in the sales data generated in accordance with the above alert patterns A to H.

The user interface unit 14 includes, for example, various input devices, display devices, and the like. The user interface unit 14 receives an input of an operation, data, or the like from the user, and controls display of the advice generated by the advice creating unit 13, Note that, for example, a display device can be provided separately from the user interface unit 14, and the user interface unit 14 can control display of an external display device.

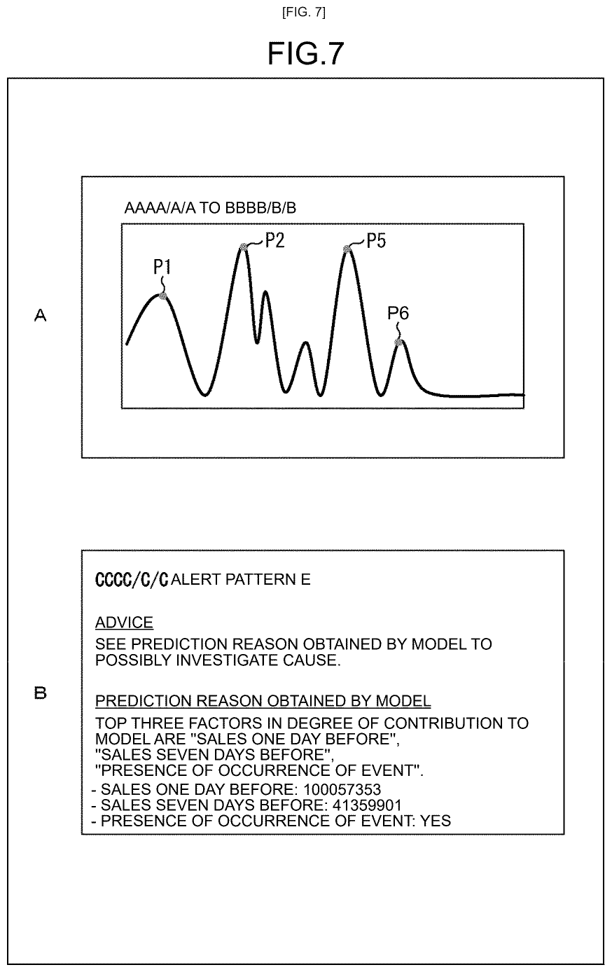

FIG. 7 is a diagram illustrating an example of information displayed on the user interface unit 14.

As illustrated in A of FIG. 7, the user interface unit 14 displays a sales data monitoring screen. On the sales data monitoring screen, a graph visualizing the sales data and alert points are displayed, the alert portions indicating the sales values in each of which the abnormality is detected by at least one of the detection model 21 and the detection model 22.

In the example of A of FIG. 7, the peaks P1, P2, P5, and P6 are indicated by gray circles on the graph as the alert points. The graph and the alert points displayed on the sales data monitoring screen are generated as visualized information by, for example, the user interface unit 14. Note that information in another format such as a table visualizing time-series data may be displayed as the visualized information.

The user can select an optional alert point by operating the user interface unit 14 or the like. When the alert point is selected, the user interface unit 14 displays a detection reason checking screen, for example, as illustrated in B of FIG. 7. On the detection reason checking screen, the alert pattern, the advice, and the prediction reason obtained by the detection model 21 are displayed as the presentation information regarding the cause of the abnormality in the sales data.

In the example of B of FIG. 7, it is displayed that the alert pattern is the alert pattern E, and the content urging the user to check the prediction reason obtained by the detection model 21 is displayed as the advice. As the prediction reason obtained by the detection model 21, the top three factors having a high degree of contribution to the prediction value are the sales value one day before, the sales value seven days before, and the presence of occurrence of an event, and detailed information of each factor are displayed. The prediction reason obtained by the detection model 21 displayed on the detection reason checking screen is generated, for example, by the user interface unit 14 on the basis of the degree of contribution of each factor to the prediction value. Note that, as the prediction reason obtained by the detection model 21, the degree of contribution of each factor to the prediction value may be displayed on the detection reason checking screen or the like.

FIG, 8 is a diagram illustrating a flow in which the user uses the information processing apparatus 1.

First, the user inputs daily sales data to the information processing apparatus 1 as indicated by an arrow #1.

Next, the information processing apparatus 1 monitors the input sales data to detect an abnormality in the sales data, and presents an alert pattern to the user as indicated by an arrow #2. In a case where the alert is not output by the detection model 21 and the alert is output by the detection model 22 (for example, the alert pattern E), the information processing apparatus 1 presents advice of urging the user to check the prediction reason obtained by the detection model 21 together with the alert pattern.

In this case, as illustrated by an arrow #3-1, the user can check the prediction reason obtained by the detection model 21 presented by the information processing apparatus 1 and know that, for example, the occurrence of an event is a trigger for increasing the sales.

When an abnormality in the sales data is detected, in a case where the alert is output by the detection model 21 and the alert is output by the detection model 22 (for example, the alert pattern C), the information processing apparatus 1 presents advice of urging the user to investigate a factor of a rapid increase in sales from external data other than handheld data such as sales data and auxiliary data, together with the alert pattern.

In this case, as indicated by an arrow #3-2, the user checks a factor of the rapid increase in sales from the external data other than the handheld data. For example, the user can check the news of the date when the abnormality is detected, and know that the sales have rapidly increased because users have migrated from a game of a competitor due to cancellation of release of the game.

### 2. Operation of Information Processing Apparatus

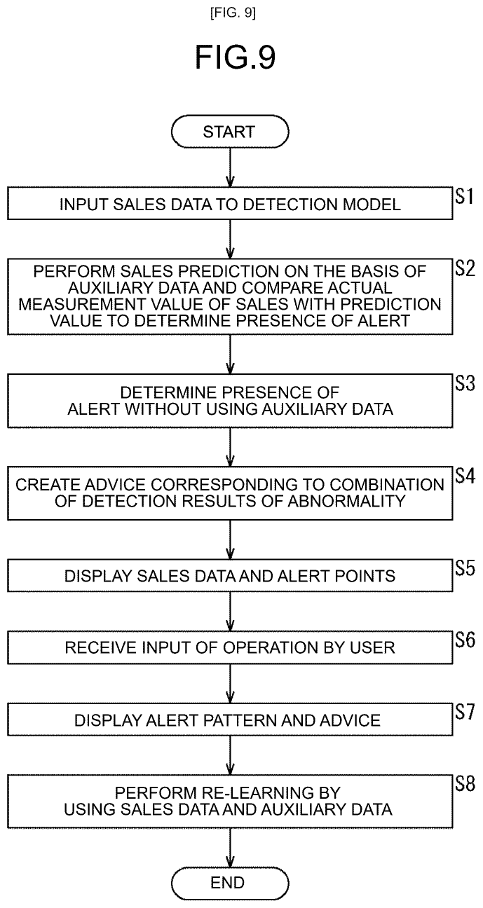

Processing performed by the information processing apparatus 1 having the above configuration will be described with reference to the flowchart in FIG. 9.

In step S1, the data monitoring unit 11 receives inputs of sales data and auxiliary data, and inputs the input sales data to the detection model 21 and the detection model 22. The data monitoring unit 11 inputs the auxiliary data to the detection model 21 together with the sales data.

In step S2, the detection model 21 performs sales prediction on the basis of the auxiliary data, and detects an abnormality in the sales data by comparing an actual measurement value of the sales with a prediction value. The detection model 21 determines the presence of an alert according to a detection result of the abnormality. For example, in a case where the sales data and the auxiliary data on November 30th are input in step S2, the detection model 21 acquired by learning using the sales data and the auxiliary data up to November 29th is used to detect the abnormality in the sales data on November 30th.

In step S3, the detection model 22 detects the abnormality in the sales data without using the auxiliary data, and determines the presence of an alert according to the detection result of the abnormality.

In step S4, the advice creating unit 13 creates advice corresponding to the alert pattern.

In step 85, the user interface unit 14 displays a graph visualizing the sales data and alert points.

In step S6, the user interface unit 14 receives an input of an operation by the user. For example, the user selects the alert point displayed on the user interface unit 14.

In step S7, the user interface unit 14 displays an alert pattern and advice for the alert point selected by the user.

In step S8, the data monitoring unit 11 performs re-learning of the detection model 21 by using the sales data and the auxiliary data. As described above, in a case where the sales data and the auxiliary data on November 30th are input in step S2, the data monitoring unit 11 acquires the detection model 21 again by learning using the sales data and the auxiliary data up to November 30th.

As described above, in the information processing apparatus 1, time-series data is monitored by using the detection model 21 that detects an abnormality in the time-series data by using the auxiliary data and the detection model 22 that detects an abnormality in the time-series data without using the auxiliary data. Specifically, the time-series data is input to each of the detection model 21 and the detection model 22, and the auxiliary data is additionally input to the detection model 21.

In a case where the abnormality in the time-series data is detected only by the detection model 21, even if the degree of contribution of the feature amount of the auxiliary data to the prediction value can be calculated, it is not possible to accurately estimate the detection result in a case where the abnormality is detected without using the auxiliary data as in the detection model 22.

The information processing apparatus 1 can determine whether or not the abnormality in the sales data is caused by the information indicated by the auxiliary data, by combining the detection result of the abnormality by the detection model 21 and the detection model 22. In a case where it is determined that the abnormality in the sales data is caused by the information indicated by the auxiliary data, the user can know the cause of the abnormality in the sales data by the information processing apparatus 1 presenting the prediction reason obtained by the detection model 21. Furthermore, in a case where it is determined that the abnormality in the sales data is not caused by the information indicated by the auxiliary data, the information processing apparatus 1 can present a trigger for the user to investigate a cause of the abnormality in the sales data by using information other than the sales data and the auxiliary data.

The information processing apparatus 1 can prevent the detection failure of the abnormality in the sales data by using the detection model 21 and the detection model 22 in the detection of the abnormality in the time-series data.

Note that the time-series data monitored by the information processing apparatus 1 is not limited to sales data in a predetermined game title, and may be stock prices, exchange rates, traffic volume at a specific point, people flow in major cities or major stations, or the like.

### Configuration Example of Computer

The above-described series of processing can be executed by hardware or software. In a case where the series of processing is executed by software, a program constituting the software is installed from a program recording medium to a computer incorporated in dedicated hardware, a general-purpose personal computer, or the like.

FIG, 10 is a block diagram illustrating a configuration example of hardware of a computer that executes the above-described series of processing by a program.

A central processing unit (CPU) 101, a read only memory (ROM) 102, and a random access memory (RAM) 103 are mutually connected by a bus 104.

An input/output interface 105 is further connected to the bus 104. An input unit 106, an output unit 107, a storage unit 108, a communication unit 109, and a drive 110 are connected to the input/output interface 105. The drive 110 drives a removable medium 111 such as a magnetic disk, an optical disk, a magneto-optical disk, or a semiconductor memory.

In the computer configured as described above, for example, the CPU 101 loads a program stored in the storage unit 108 into the RAM 103 via the input/output interface 105 and the bus 104 and executes the program to cause the above-described series of processing to be performed.

The program executed by the CPU 101 is provided, for example, by being recorded in the removable medium 111 or via a wired or wireless transmission medium such as a local area network, the Internet, or digital broadcasting, and is installed in the storage unit 108.

Note that the program executed by the computer may be a program in which processing is performed in time series in the order described herein, or may be a program in which processing is performed in parallel or at necessary timing such as when a call is made.

Note that the effects described herein are merely examples and are not limited, and other effects may be provided.

The embodiment of the present technology is not limited to the above-described embodiment, and various modifications can be made without departing from the gist of the present technology.

For example, the present technology can have a configuration of cloud computing in which one function is shared and processed in cooperation by a plurality of devices via a network.

Furthermore, each step described in the above-described flowchart can be executed by one device or can be shared and executed by a plurality of devices.

Furthermore, in a case where a plurality of pieces of processing is included in one step, the plurality of pieces of processing included in the one step can be executed by one device or can be shared and executed by a plurality of devices.

### Combination Example of Configuration

The present technology can also have the following configurations.

(1) An information processing apparatus comprising
a presentation control unit that generates presentation information corresponding to a combination of a detection result obtained by a first detection model that detects an abnormality in time-series data by using auxiliary data related to variation in the time-series data and a detection result obtained by a second detection model that detects an abnormality in the time-series data without using the auxiliary data.

(2) The information processing apparatus according to (1), wherein
the presentation control unit further generates visualized information obtained by visualizing the time-series data.

(3) The information processing apparatus according to (2), wherein
the visualized information includes a value of the time-series data in which an abnormality is detected by at least one of the first detection model and the second detection model.

(4) The information processing apparatus according to any one of (1) to (3), wherein
the presentation control unit generates the presentation information regarding an abnormality of the time-series data.

(5) The information processing apparatus according to (4), wherein
the presentation control unit generates, as the presentation information, advice on a cause of an abnormality of the time-series data.

(6) The information processing apparatus according to (5), wherein
the first detection model acquires a prediction value corresponding to the time-series data on a basis of the auxiliary data, and detects an abnormality of the time-series data by comparing the time-series data with the prediction value.

(7) The information processing apparatus according to (6), wherein
the first detection model outputs information indicating a factor by which the prediction value is acquired, and
the presentation control unit generates the presentation information including the information indicating the factor.

(8) The information processing apparatus according to (7), wherein
the information indicating the factor is generated on a basis of a degree of contribution of each of the time-series data of a past and a feature amount of the auxiliary data to the prediction value.

(9) The information processing apparatus according to (7) or (8), wherein,
in a case where an abnormality has not been detected by the first detection model, the presentation control unit generates the advice of urging a user to check information indicating the factor.

(10) The information processing apparatus according to any one of (5) to (9), wherein,
in a case where an abnormality has been detected by the first detection model, the presentation control unit generates the advice of urging a user to check other data different from the time-series data and the auxiliary data.

(11) The information processing apparatus according to any one of (1) to (10), wherein
the first detection model is an inference model acquired in advance by learning using the time-series data and the auxiliary data.

(12) The information processing apparatus according to (11), wherein
the auxiliary data indicates a discrete value.

(13) The information processing apparatus according to (11) or (12), further comprising
a monitoring unit that detects an abnormality in the time-series data by using the first detection model and the second detection model.

(14) The information processing apparatus according to (13), wherein,
in a case where the time-series data is newly input, the monitoring unit performs re-learning of the first detection model by using the time-series data and the auxiliary data.

(15) An information processing method performed by an information processing apparatus, the method comprising
generating presentation information corresponding to a combination of a detection result obtained by a first detection model that detects an abnormality in time-series data by using auxiliary data related to variation in the time-series data and a detection result obtained by a second detection model that detects an abnormality in the time-series data without using the auxiliary data.

(16) A program causing a computer to execute processing of
generating presentation information corresponding to a combination of a detection result obtained by a first detection model that detects an abnormality in time-series data by using auxiliary data related to variation in the time-series data and a detection result obtained by a second detection model that detects an abnormality in the time-series data without using the auxiliary data.

### Reference Signs List

1 INFORMATION PROCESSING APPARATUS
11 DATA MONITORING UNIT
12 ALERT PATTERN DISCRIMINATION UNIT
13 ADVICE CREATING UNIT
14 USER INTERFACE UNIT
21, 22 DETECTION MODEL

1. An information processing apparatus comprising
a presentation control unit that generates presentation information corresponding to a combination of a detection result obtained by a first detection model that detects an abnormality in time-series data by using auxiliary data related to variation in the time-series data and a detection result obtained by a second detection model that detects an abnormality in the time-series data without using the auxiliary data.

2. The information processing apparatus according to claim 1, wherein
the presentation control unit further generates visualized information obtained by visualizing the time-series data.

3. The information processing apparatus according to claim 2, wherein
the visualized information includes a value of the time-series data in which an abnormality is detected by at least one of the first detection model and the second detection model.

4. The information processing apparatus according to claim 1, wherein
the presentation control unit generates the presentation information regarding an abnormality of the time-series data.

5. The information processing apparatus according to claim 4, wherein
the presentation control unit generates, as the presentation information, advice on a cause of an abnormality of the time-series data.

6. The information processing apparatus according to claim 5, wherein
the first detection model acquires a prediction value corresponding to the time-series data on a basis of the auxiliary data, and detects an abnormality of the time-series data by comparing the time-series data with the prediction value.

7. The information processing apparatus according to claim 6, wherein
the first detection model outputs information indicating a factor by which the prediction value is acquired, and
the presentation control unit generates the presentation information including the information indicating the factor.

8. The information processing apparatus according to claim 7, wherein
the information indicating the factor is generated on a basis of a degree of contribution of each of the time-series data of a past and a feature amount of the auxiliary data to the prediction value.

9. The information processing apparatus according to claim 7, wherein,
in a case where an abnormality has not been detected by the first detection model, the presentation control unit generates the advice of urging a user to check information indicating the factor.

10. The information processing apparatus according to claim 5, wherein,
in a case where an abnormality has been detected by the first detection model, the presentation control unit generates the advice of urging a user to check other data different from the time-series data and the auxiliary data.

11. The information processing apparatus according to claim 1, wherein
the first detection model is an inference model acquired in advance by learning using the time-series data and the auxiliary data.

12. The information processing apparatus according to claim 11, wherein
the auxiliary data indicates a discrete value.

13. The information processing apparatus according to claim 11, further comprising
a monitoring unit that detects an abnormality in the time-series data by using the first detection model and the second detection model.

14. The information processing apparatus according to claim 13, wherein,
in a case where the time-series data is newly input, the monitoring unit performs re-learning of the first detection model by using the time-series data and the auxiliary data.

15. An information processing method performed by an information processing apparatus, the method comprising
generating presentation information corresponding to a combination of a detection result obtained by a first detection model that detects an abnormality in time-series data by using auxiliary data related to variation in the time-series data and a detection result obtained by a second detection model that detects an abnormality in the time-series data without using the auxiliary data.

16. A program causing a computer to execute processing of
generating presentation information corresponding to a combination of a detection result obtained by a first detection model that detects an abnormality in time-series data by using auxiliary data related to variation in the time-series data and a detection result obtained by a second detection model that detects an abnormality in the time-series data without using the auxiliary data.
